(19) United States
(12) Patent Application Publication
(10) Pub. No.: US 2016/0343459 A1
(43) Pub. Date: Nov. 24, 2016

(54) GAS MONITORING SYSTEM AND METHOD FOR NUCLEAR REACTOR

(71) Applicant: Nexceris, LLC, Lewis Center, OH (US)

(72) Inventors: Douglas A. Mitchell, Plain City, OH (US); Lora B. Thrun, Grove City, OH (US); Stephen R. Cummings, Worthington, OH (US); Chad T. Sellers, Lewis Center, OH (US); Andrew P. Smith, Columbus, OH (US); William J. Dawson, Dublin, OH (US); Scott L. Swartz, Columbus, OH (US)

(21) Appl. No.: 15/157,171

(22) Filed: May 17, 2016

Related U.S. Application Data
(60) Provisional application No. 62/163,326, filed on May 18, 2015.

(51) Int. Cl. G21C 17/00

(52) U.S. Cl. CPC G21C 17/00

(57) ABSTRACT

A gas monitoring system and method are provided. In one embodiment, a gas monitoring system includes a gas monitoring unit in a reactor containment environment, a gas monitoring unit controller in a reactor non-containment environment, and a high temperature or industry compliant cable interconnecting the gas monitoring unit with the gas monitoring unit controller. Various sensors on the gas monitoring unit detect conditions of the reactor containment environment, including hydrogen gas concentration.

### CROSS-REFERENCE TO RELATED APPLICATIONS

This application claims priority from U.S. Provisional Patent Application No. 62/163,326 filed on May 18, 2015, which is incorporated by reference herein in its entirety.

### BACKGROUND

Hydrogen gas is generated in nuclear reactors under a variety of operating conditions. If mitigating actions are not taken, hydrogen concentrations can reach flammable levels.

Gas analyzers are currently used to measure the hydrogen concentration in reactor containment environments. The analyzers are located outside of reactor containment, and sample gases are pulled to the analyzer through tubes that penetrate through the containment wall. These penetrations create potential leak paths for hydrogen and other dangerous species to escape out of containment. Response times for current gas analyzers are long. Current gas analyzers are power intensive and therefore cannot run for long on backup power when a nuclear accident occurs.

The present application is directed to novel systems and methods for measuring hydrogen gas concentrations from a nuclear reactor.

### SUMMARY

In one embodiment, a gas monitoring system for nuclear reactors is provided, the gas monitoring system comprising: a gas monitoring unit within a reactor containment; a gas monitoring unit controller outside of the reactor containment; and a high temperature or industry compliant cable connecting the gas monitoring unit to the gas monitoring unit controller.

In one embodiment, a method for monitoring gases in a nuclear reactor is provided, the method comprising the acts of: reading an input signal from at least one of: at least one hydrogen sensor, a pressure sensor, an oxygen sensor, a temperature sensor, and a relative humidity or steam sensor; processing the input signal through a calibration algorithm in a software to obtain information about a reactor containment environment; communicating the information of the reactor containment environment as at least one of: feedback to another instrumentation for the nuclear reactor; display information output on a display panel or electronic display; and data to be recorded to a data acquisition system.

In another embodiment, a method for detecting hydrogen gas is provided, the method comprising the acts of: providing a hydrogen sensor comprising a hydrogen-selective porous composite comprising a cerium oxide; providing a hydrogen-comprising gas; contacting the hydrogen-comprising gas with the hydrogen-selective porous composite; and detecting hydrogen in the hydrogen-comprising gas according to a decrease in electrical resistance, a change in sensitivity, or a deviation from baseline operation of a hydrogen-selective porous composite may be used to detect a hydrogen-comprising gas.

In another embodiment, a method for detecting hydrogen gas is provided, the method comprising the acts of: providing a hydrogen sensor comprising a hydrogen-selective porous composite comprising a doped cerium oxide selected from the group chosen from: zirconium-doped ceria, gadolinium-doped ceria, samarium-doped ceria, lanthanum-doped ceria, yttrium-doped ceria, calcium-doped ceria, strontium-doped ceria, and a mixture thereof; a modifier comprising at least one of: tin oxide, indium oxide, titanium oxide, copper oxide, tungsten oxide, molybdenum oxide, nickel oxide, niobium oxide, or vanadium oxide; and a noble metal promoter comprising one or more of: palladium, ruthenium, platinum, gold, rhodium, and iridium; providing a hydrogen-comprising gas; contacting the hydrogen-comprising gas with the hydrogen-selective porous composite; and detecting hydrogen in the hydrogen-comprising gas according to a decrease in electrical resistance, a

change in sensitivity, or a deviation from baseline operation of the hydrogen-selective porous composite.

### BRIEF DESCRIPTION OF THE DRAWINGS

The accompanying figures, which are incorporated in and constitute a part of the specification, illustrate various example systems, methods, and results, and are used merely to illustrate various example embodiments.

FIG. 1 illustrates an example gas monitoring system.

FIG. 2 illustrates an example gas monitoring controller.

FIG. 3 illustrates an example gas monitoring unit.

FIG. 4 is a flow chart of an example signal algorithm for sensors and outputs.

FIG. 5 illustrates example sensor response.

FIG. 6 illustrates example sensor response.

FIG. 7 illustrates example sensor sensitivity.

FIG. 8 illustrates example sensor sensitivity.

FIG. 9 illustrates example sensor sensitivity as a function of temperature.

FIG. 10 illustrates example sensor response.

FIG. 11 illustrates an example gas monitoring unit.

FIG. 12A illustrates example sensor results.

FIG. 12B illustrates example sensor results.

FIG. 13A illustrates example sensor results.

FIG. 13B illustrates example sensor results.

FIG. 14A illustrates example sensor results.

FIG. 14B illustrates example sensor results.

FIG. 15A illustrates example sensor results.

FIG. 15B illustrates example sensor results.

FIG. 16 illustrates example sensor sensitivity.

### DETAILED DESCRIPTION

The embodiments disclosed and claimed herein depict and describe a gas monitoring system for nuclear reactors.

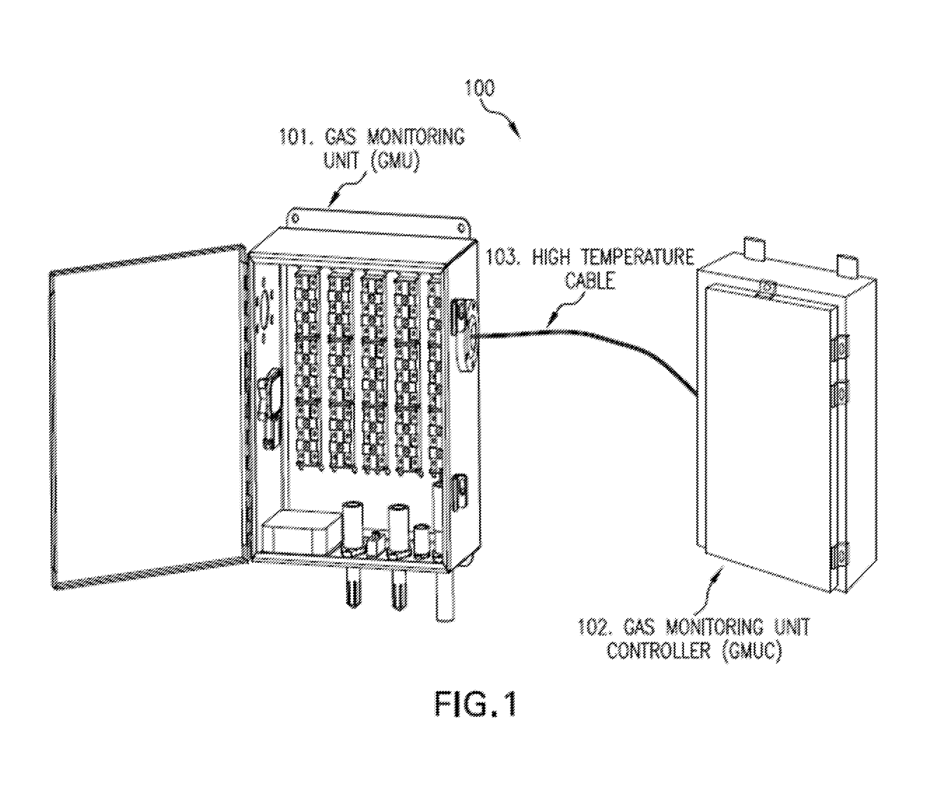

With reference to FIG. 1, an example gas monitoring system 100 is illustrated. Gas monitoring system 100 may measure hydrogen gas concentrations throughout a nuclear reactor. Gas monitoring system 100 may measure hydrogen gas concentrations throughout a nuclear power plant. Gas monitoring system 100 may detect hydrogen gas both inside and outside of reactor containment, over a range of conditions. In one embodiment, a reactor operating condition is normal. In another embodiment, a reactor operating condition is a severe accident. Gas monitoring system 100 may measure and account for a wide range of environmental variables, including, but not limited to: temperature, pressure, steam, and oxygen, and gas monitoring system 100 may provide a stable hydrogen concentration signal under all target conditions. Gas monitoring system 100 may also be adapted to also detect carbon monoxide, cesium iodide, methyl iodide, fuel contaminants, and other gases indicative of a nuclear accident or reactor leak. Gas monitoring system 100 may also be adapted to also detect at least one of: carbon monoxide, cesium iodide, methyl iodide, fuel contaminants, and other gases indicative of a nuclear accident or reactor leak.

In one embodiment, gas monitoring system 100 operates inside reactor containment and is capable of operating from ambient temperature and pressure up to 700° C. and 1.3 MPa, respectively, which covers operating states from normal reactor operation to severe accident conditions such as reactor overheating and meltdown. 1.3 MPa may be the critical pressure of hydrogen. Gas monitoring system 100 may measure gases in real time, so as to provide a fast response time of less than about a minute. Gas monitoring system 100 may operate inside reactor containment and may be capable of operating from ambient

temperature up to 700° C. Gas monitoring system 100 may operate inside reactor containment and may be capable of operating from ambient pressure up to 1.3 MPa. Gas monitoring system 100 may operate inside reactor containment and may be capable of operating from ambient temperature up to about 700° C. Gas monitoring system 100 may operate inside reactor containment and may be capable of operating from ambient pressure up to about 1.3 MPa.

Gas monitoring system 100 may be capable of measuring hydrogen over a wide range of reactor conditions, for example, in a nuclear power plant. Gas monitoring system 100 may include a gas monitoring unit (GMU) 101. GMU 101 may be located inside reactor containment. Gas monitoring system 100 may include a gas monitoring unit controller (GMUC) 102. GMUC 102 may be located outside of reactor containment. A high temperature or industry compliant cable 103 may connect GMU 101 with GMUC 102 through penetration in a reactor containment wall. GMU 101 may measure hydrogen concentration, oxygen concentration, pressure, and steam concentration or relative humidity inside reactor containment. GMU 101 may measure at least one of: hydrogen concentration, oxygen concentration, pressure, and steam concentration or relative humidity inside reactor containment. Signals from GMU 101 are communicated via high temperature or industry compliant cable 103 to GMUC 102. GMUC 102 may receive different raw sensor signals and may process raw sensor signals through a calibration and deconvolution algorithm to report a final hydrogen concentration, temperature, oxygen concentration, pressure, and relative humidity or water concentration. GMUC 102 may receive different raw sensor signals and may process raw sensor signals through a calibration and deconvolution algorithm to report at least one of: a final hydrogen concentration, temperature, oxygen concentration, pressure, and relative humidity or water concentration. Processed raw sensor signals may be fed to other instrumentation and systems within, for example, a nuclear power plant, displayed on a display panel or electronic display, or be recorded to a data acquisition system.

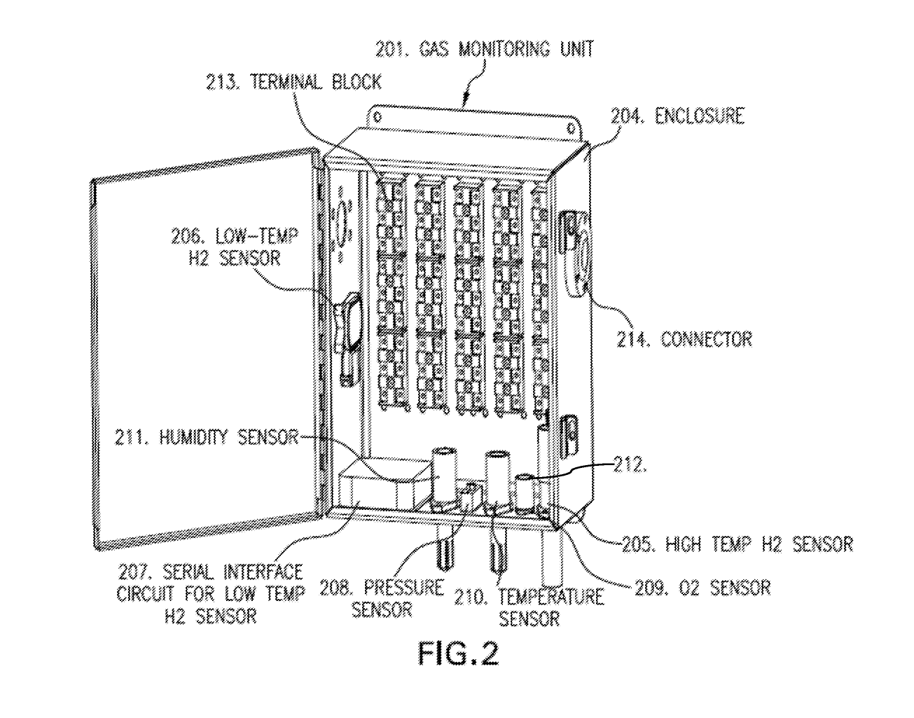

With reference to FIG. 2, an example gas monitoring unit (GMU) 201 is illustrated. GMU 201 may comprise any variety of enclosure, including for example a stainless steel enclosure 204. Located within stainless steel enclosure 204 may be a high temperature hydrogen sensor 205, a low temperature hydrogen sensor 206, a pressure sensor 208, an oxygen sensor 209, a temperature sensor 210, and a relative humidity or steam sensor 211. A circuit board 207 may be provided to convert an analog output from lower temperature hydrogen sensor 206 to a digital out. In one embodiment, circuit board 207 is incorporated into GMUC 102 (FIG. 1). In another embodiment, circuit board 207 is eliminated. High temperature wires 212 may connect at least two of: power input leads, signal leads, and ground leads for sensors 205, 206, 208, 209, 210, and 211 to one or more ceramic terminal blocks 213. High temperature wires 212 may be further connected to a connector 214 mounted on a wall of enclosure 204, or high temperature wires 212 may be left unterminated to connect directly to high temperature or industry compliant cable 103 running to GMUC 102 (FIG. 1). A connection of high temperature wires 212 may be made through direct splicing, using ring terminals, or using any other high temperature connection mechanism. A flame arrestor (not shown), such as a metal screen or mesh, may be used to envelop at least one of sensors 205, 206, 208, 209, 210, and 211 to prevent potential ignition or retard flame propagation. GMU 201 may be designed using materials to be robust to nuclear accident conditions including at least one of: high radiation, pressure, temperature, steam, and low oxygen concentrations.

High temperature hydrogen sensor 205 of GMU 201 may use a hydrogen-selective porous composite to detect a hydrogen-comprising gas. Hydrogen-selective porous composite may comprise cerium oxide, such that contacting a hydrogen-selective porous composite with a hydrogen-comprising gas may cause a decrease in electrical resistance, change in sensitivity, or deviation from baseline operation in a hydrogen-selective porous composite. In another embodiment, high temperature hydrogen sensor 205 of GMU 201 employs a porous hydrogen selective composite material comprising a doped cerium oxide selected from the group chosen from: zirconium-doped ceria, gadolinium-doped ceria, samarium-doped ceria, lanthanum-doped ceria, yttrium-doped ceria, calcium-doped ceria, strontium-doped ceria, and a mixture thereof; a modifier comprising at least one of: tin oxide, indium oxide, titanium oxide, copper oxide, tungsten oxide, molybdenum oxide, nickel oxide, niobium oxide, or vanadium oxide; and a noble metal promoter comprising one or more of: palladium, ruthenium, platinum, gold, rhodium, and iridium. A decrease in electrical resistance, a change in sensitivity, or a deviation from baseline operation of a hydrogen-selective porous composite may be used to detect a hydrogen-comprising gas.

High temperature hydrogen sensor 205 of GMU 201 may operate at ambient temperatures occurring during nuclear accidents—that is, 150° C. to 700° C., and pressures ranging from a vacuum to 1.3 MPa. High temperature hydrogen sensor 205 of GMU 201 may operate at ambient temperatures occurring during nuclear accidents—that is, about 150° C. to about 700° C. (or 150° C. to 700° C.), and pressures ranging from a vacuum to about 1.3 MPa. High temperature hydrogen sensor 205 may include electrochemical hydrogen sensors, chemi-resistive hydrogen sensors, catalytic hydrogen sensors, metal oxide semi-conductive hydrogen sensors, and the like.

Low temperature hydrogen sensor 206 of GMU 201 may employ a porous hydrogen selective composite material comprising a doped cerium oxide selected from the group chosen from: zirconium-doped ceria, gadolinium-doped ceria, samarium-doped ceria, lanthanum-doped ceria, yttrium-doped ceria, calcium-doped ceria, strontium-doped ceria, and a mixture thereof; a modifier comprising at least one of: tin oxide, indium oxide, titanium oxide, copper oxide, tungsten oxide, molybdenum oxide, nickel oxide, niobium oxide, and vanadium oxide; and a noble metal promoter comprising one or more of: palladium, ruthenium, platinum, gold, rhodium, and iridium.

Lower temperature hydrogen sensor 206 of GMU 201 may operate at ambient temperatures that may occur under normal reactor conditions (non-accident) in, for example, a nuclear power plant, in temperatures of about 25° C. to about 150° C. Lower temperature hydrogen sensor 206 may be an electrochemical hydrogen sensor, a chemi-resistive hydrogen sensor, a catalytic hydrogen sensor, a metal oxide semi-conductive hydrogen sensor, and the like.

Oxygen sensor 209 may be capable of measuring oxygen for temperatures, pressures, reducing gases, and oxygen ranges from normal reactor operating conditions to severe accident operating conditions. These ranges may include temperatures of 25° C. to 700° C., pressure ranging from a vacuum to 1.3 MPa, oxygen concentrations of 0% to at least 25%, and hydrogen concentrations from 0% to 30%. These ranges may include temperatures of about 25° C. to about 700° C., pressure ranging from a vacuum to about 1.3 MPa, oxygen concentrations of about 0% to at least about 25%, and hydrogen concentrations from about 0% to about 30%. Oxygen sensor 209 may include yttrium-stabilized zirconium oxide, gadolinium or samarium doped cerium oxide oxygen sensors, titanium oxide-based oxygen sensors, and the like.

Pressure sensor 208 of GMU 201 may be capable of measuring static pressure over temperature and pressure ranges expected for normal reactor operating conditions to severe accident conditions. Pressure sensor 208 may operate in temperature conditions from 25° C. to 700° C., and in pressure ranges from 0.0 MPa to at least 1.3 MPa. Pressure sensor 208 may operate in temperature conditions from about 25° C. to about 700° C., and in pressure ranges from about 0.0 MPa to at least about 1.3 MPa.

Humidity sensor 211 may be any relative humidity sensor 211 capable of measuring relative humidity in a nuclear containment environment from 0% to 100% relative humidity. Humidity sensor 211 may be any relative humidity sensor 211 capable of measuring relative humidity in a nuclear containment environment from about 0% to about 100% relative humidity. Humidity sensor 211 may also be any sensor capable of measuring steam content as volume percent or partial pressure of water vapor in a nuclear containment environment over a temperature and pressure range for normal reactor operating conditions to severe accident conditions. This range may include temperatures from 25° C. to 700° C. and pressures ranging from a vacuum to 1.3 MPa. This range may include temperatures from about 25° C. to about 700° C. and pressures ranging from a vacuum to about 1.3 MPa.

Temperature sensor 210 of GMU 201 may be any temperature sensor 210 capable of measuring temperature over a range of normal reactor operating conditions to severe accident conditions—that is, temperatures in the range of about 25° C. to about 700° C., or temperatures in the range of 25° C. to 700° C. Temperature sensor 210 may comprise resistance temperature devices, thermistors, thermocouples, and the like.

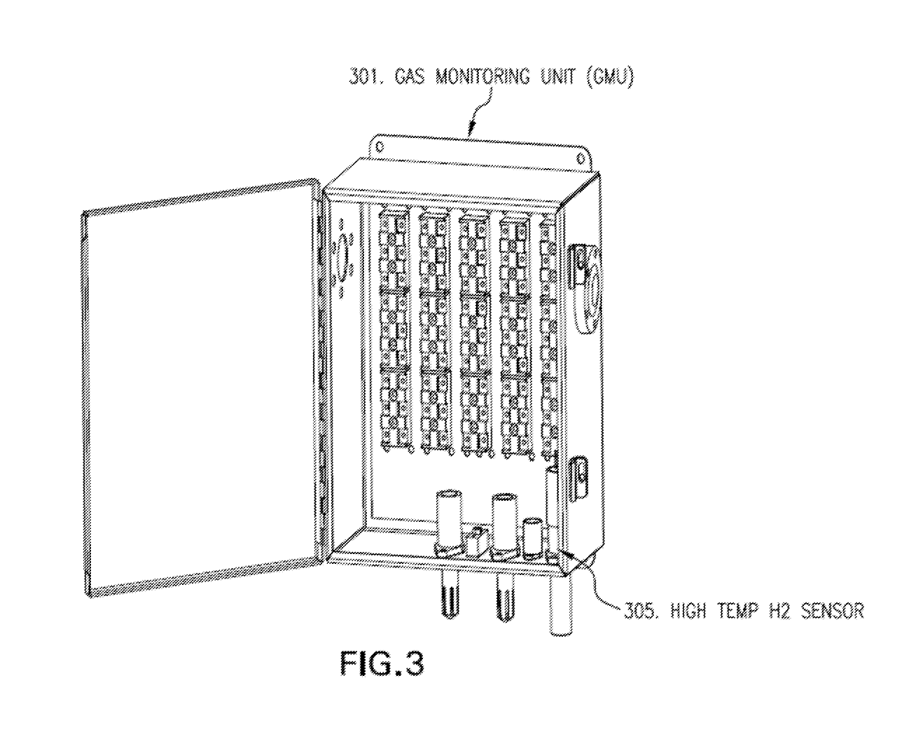

With reference to FIG. 3, an example gas monitoring unit (GMU) 301 is illustrated. GMU 301 may employ only one hydrogen sensor 305. Hydrogen sensor 305 may be configured to operate continuously at the highest required temperature, typically 700° C., and across all other pressure and oxygen, water, and hydrogen concentrations referenced herein above. Hydrogen sensor 305 may use a hydrogen-selective porous composite to detect a hydrogen-comprising gas. Hydrogen-selective porous composite may comprise cerium oxide, such that contacting a hydrogen-selective porous composite with a hydrogen-comprising gas may decrease electrical resistance, change sensitivity, or a deviate from baseline operation in a hydrogen-selective porous composite. Operating temperature, or heater power usage, and corresponding calibration may be adjusted in GMUC 102 depending on an ambient temperature measured with temperature sensor or sensor embedded temperature sensor 210, such that hydrogen sensor 305 is always controlled to a temperature higher than ambient. Operating temperature or power control loop and corresponding calibration may be adjusted in GMUC 102 depending on an ambient temperature measured by the temperature sensor or a sensor embedded temperature sensor. In one embodiment, GMUC 102 with electronic control circuit (not shown), includes hardware and firmware that reads signals from GMU sensors 205, 206, 208, 209, 210, and 211, processes read signals through a calibration, error correcting, and deconvolution algorithm programmed into firmware, and communicates information about a reactor containment environment, including information relating to hydrogen concentration, temperature, oxygen concentration, steam concentration, and pressure.

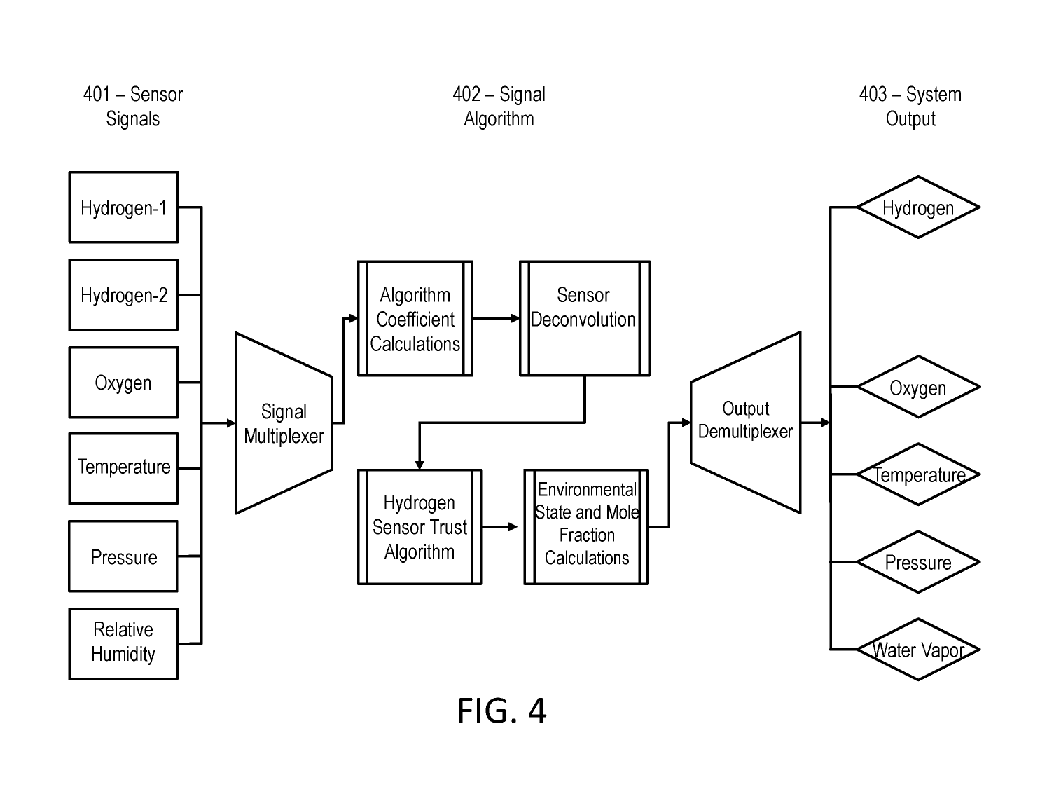

With reference to FIG. 4, an example signal algorithm 402 for sensor signals 401 and system outputs 403 is illustrated. Calibration algorithm 402 may take input signals 401 from at least one of sensors 205, 206, 208, 209, 210, and 211 (high and low temperature hydrogen sensors, pressure, oxygen, temperature, and humidity or steam sensors), and convert them to system output values 403 for hydrogen concentration, pressure, oxygen concentration, temperature, and steam concentration.

With reference again to FIGS. 1 and 2, gas monitoring system 100 may be calibrated to measure carbon monoxide instead of hydrogen. High temperature hydrogen sensor 205 and low temperature hydrogen sensor 206 may be cross-sensitive to carbon monoxide, and high temperature hydrogen sensor 205 and low temperature hydrogen sensor 206 may be calibrated for carbon monoxide. A carbon monoxide calibration may be included in the GMUC 102 calibration algorithm 402.

In one embodiment, gas monitoring system 100 may also be calibrated to measure at least one of cesium iodide, methyl iodide, iodine, and other nuclear fuel contaminants, instead of measuring hydrogen. High temperature hydrogen sensor 205 and low temperature hydrogen sensor 206 may be cross-sensitive to at least one of cesium iodide, methyl iodide, iodine, and other nuclear fuel contaminants, and high temperature hydrogen sensor 205 and low hydrogen temperature sensor 206 may be calibrated for measurement of at least one of cesium iodide, methyl iodide, iodine, and other nuclear fuel contaminants. Calibration for cesium iodide, methyl iodide, iodine, and other nuclear fuel contaminants may be included in the GMUC 102 signal algorithm 402 calibration. Gas monitoring system 100 calibrated to detect at least one of these fuel contaminants may be installed in locations in reactor containment with high probability of these gases being present, such as near fuel rods.

Any GMUs 101, 201, 301 may be installed outside of containment to measure for hydrogen concentrations in non-containment areas. Enclosures of GMUs 101, 201, 301 may be modified for wall mounting, door seal mounting, or other possible locations where hydrogen gas may be present. GMUs 101, 201, 301 may be further simplified for a non-containment environment, such as eliminating a pressure sensor, for example, pressure sensor 208.

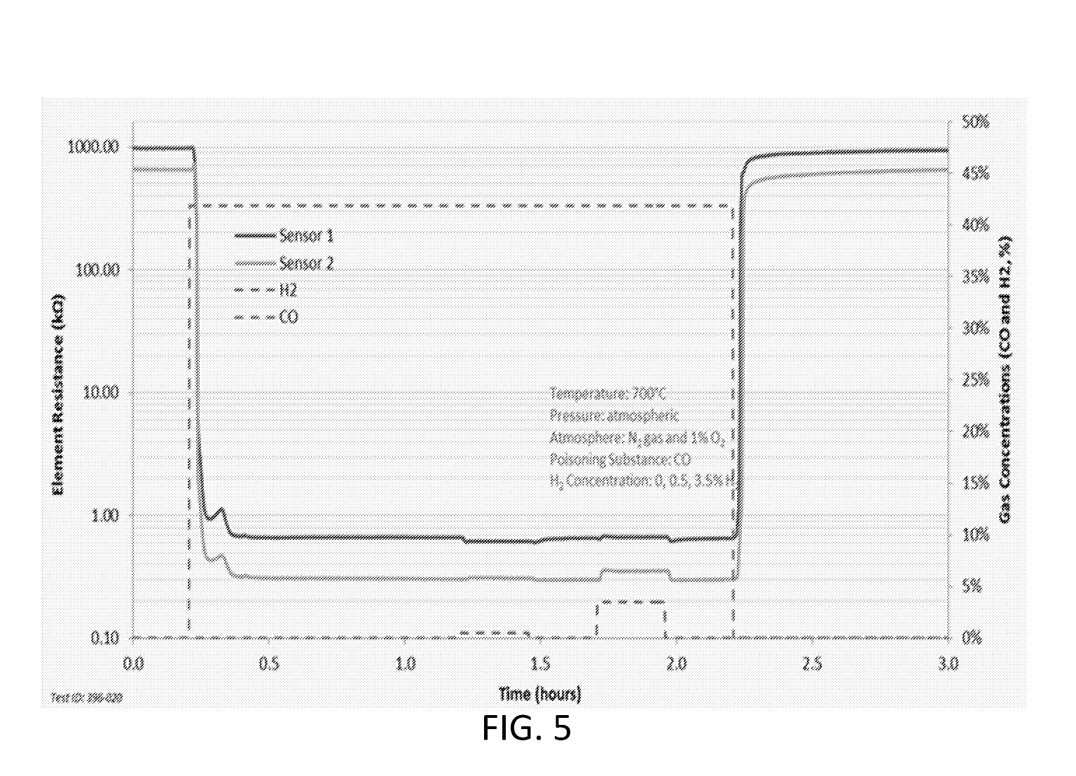

With reference to FIG. 5, an example sensor response is illustrated. Sensor response to carbon monoxide shows that gas monitoring system 100 may be used to measure carbon monoxide.

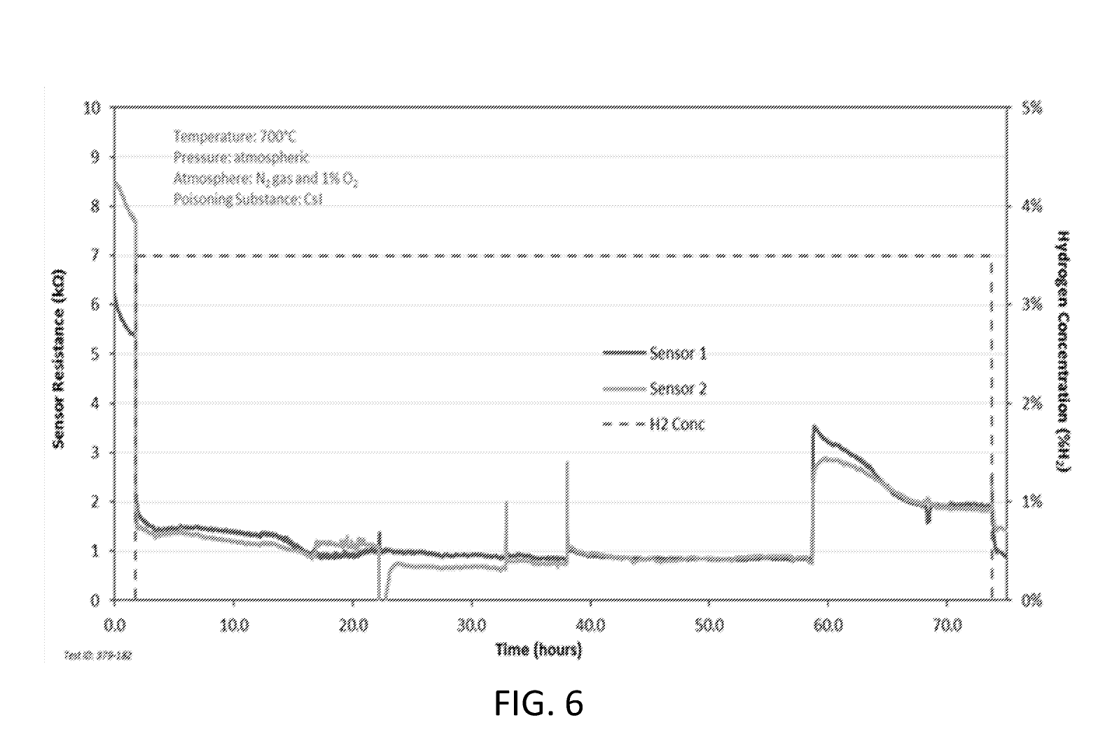

With reference to FIG. 6, an example sensor response is illustrated. Sensor response to cesium iodine shows that gas monitoring system 100 may be used to measure cesium iodide.

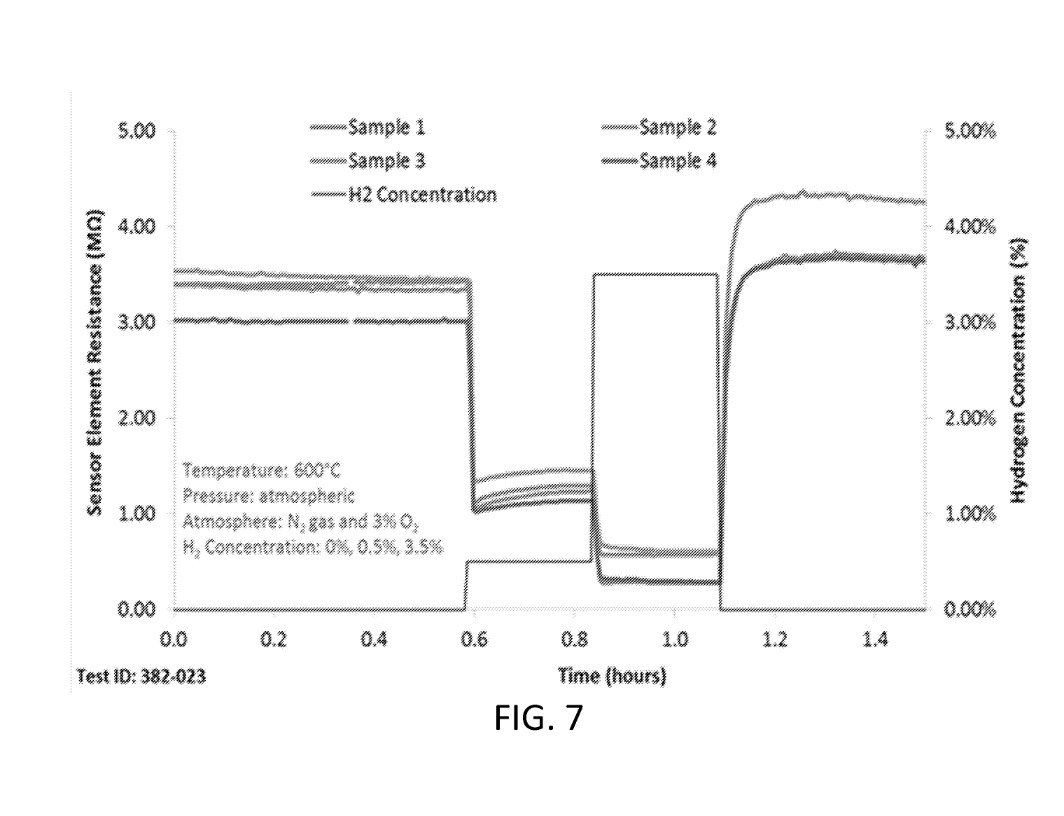

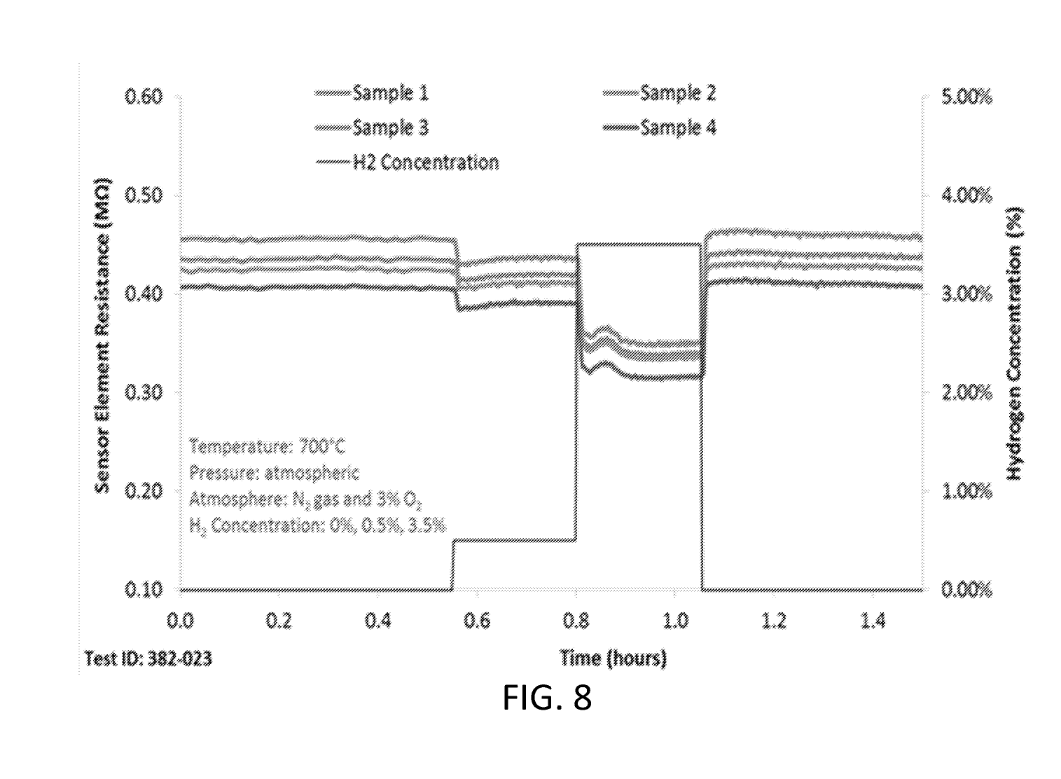

With reference to FIGS. 7 and 8, example sensor sensitivity is illustrated for hydrogen sensitivity at 600° C. and 700° C. operating temperatures, respectively.

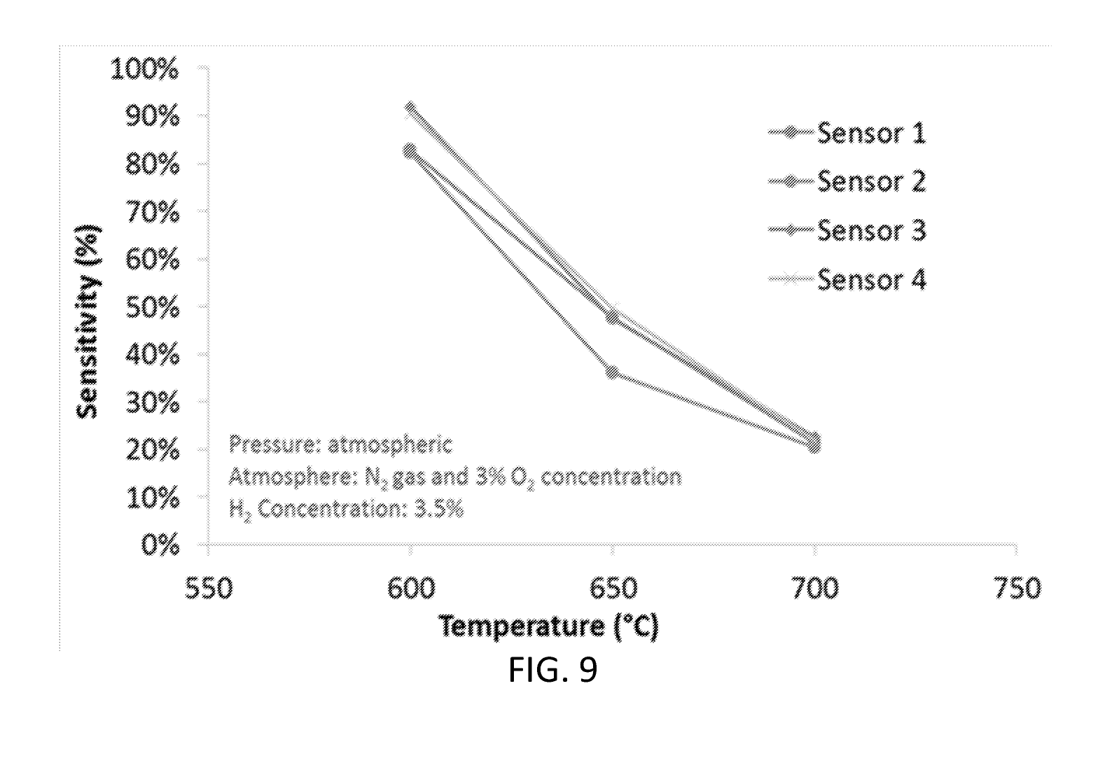

With reference to FIG. 9, example sensor sensitivity is illustrated for 3.5% H₂ as a function of temperature. For safety reasons, lab testing may be limited to testing hydrogen concentrations below 4% in the air. However, hydrogen sensor 205, may measure hydrogen over a much broader range.

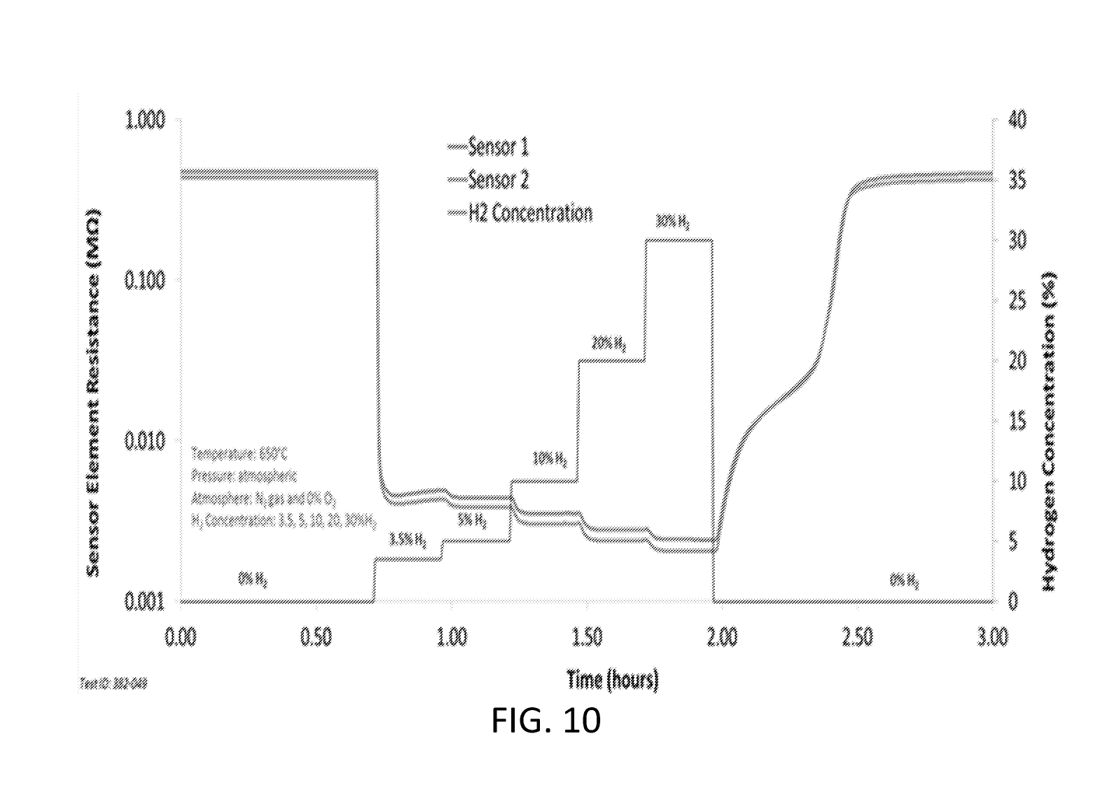

With reference to FIG. 10, an example sensor response is illustrated. In one embodiment, hydrogen sensor 205 is tested at hydrogen concentrations from 0% to 30% in a background of humidified nitrogen (holding oxygen at 0% to avoid flammable conditions). Sensitivity is observed over this entire concentration range with no evidence of signal saturation. As illustrated in FIG. 10, a response up to 30% H₂, measured at 650° C. is illustrated.

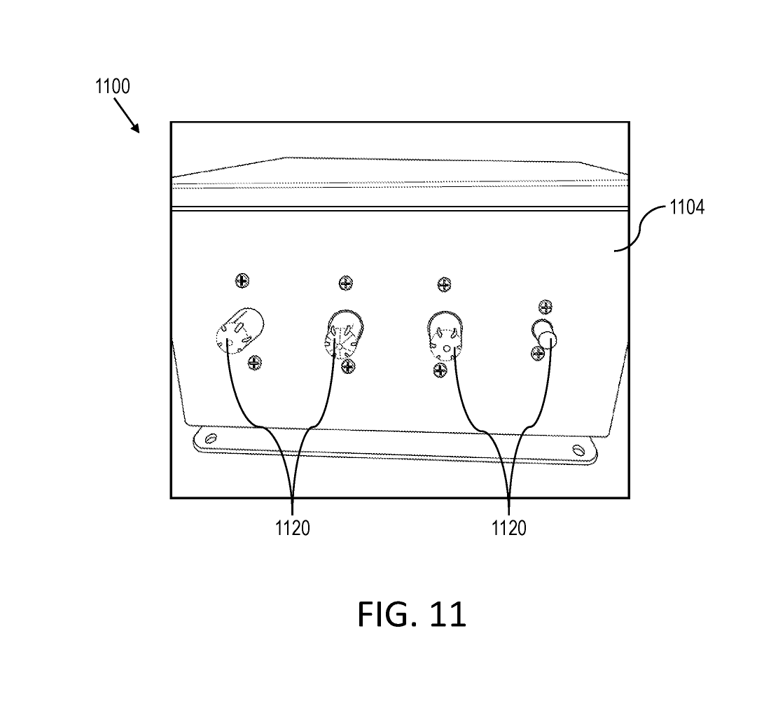

With reference to FIG. 11, an example gas measuring unit (GMU) 1100 is illustrated. Sensors 1120 may be mounted within a stainless steel or equivalent box 1102 with high temperature and radiation resistant terminal blocks and electrical connectors to connect to sensor wires. Sensors 1120 may include any of sensors 205, 206, 208, 209, 210, and 211 referenced above in the description of FIG. 2. An example GMU 1100 was mounted on a seismic table and was tested under simulated earthquake conditions of a 12 on the Richter scale. In this embodiment, seismic conditions are conducted under ambient conditions. Responses to 0%, 1%, and 2% hydrogen were collected before and after seismic testing, and sensor outputs were measured continuously throughout testing under ambient conditions.

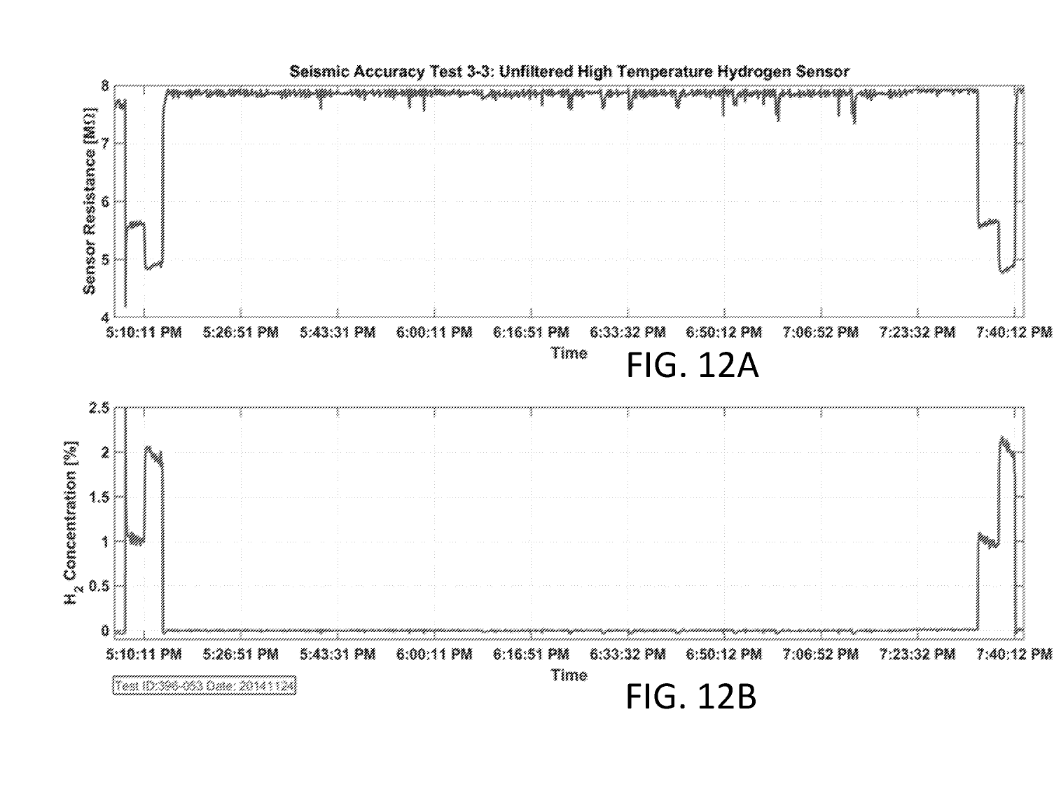

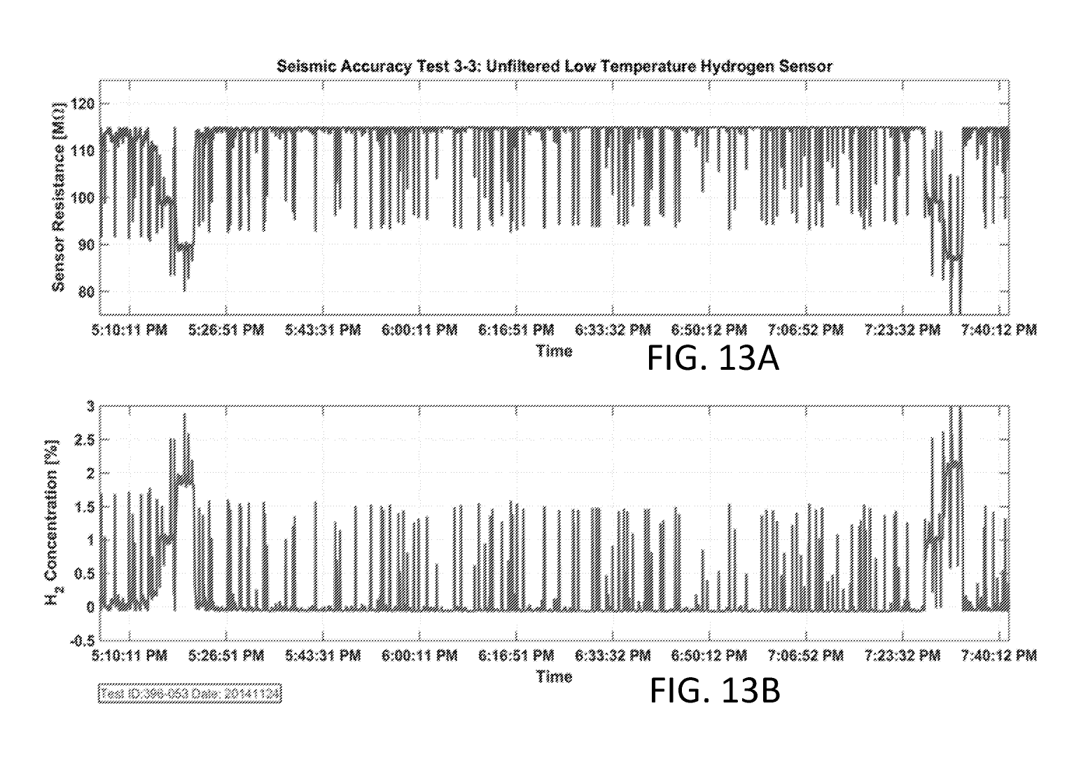

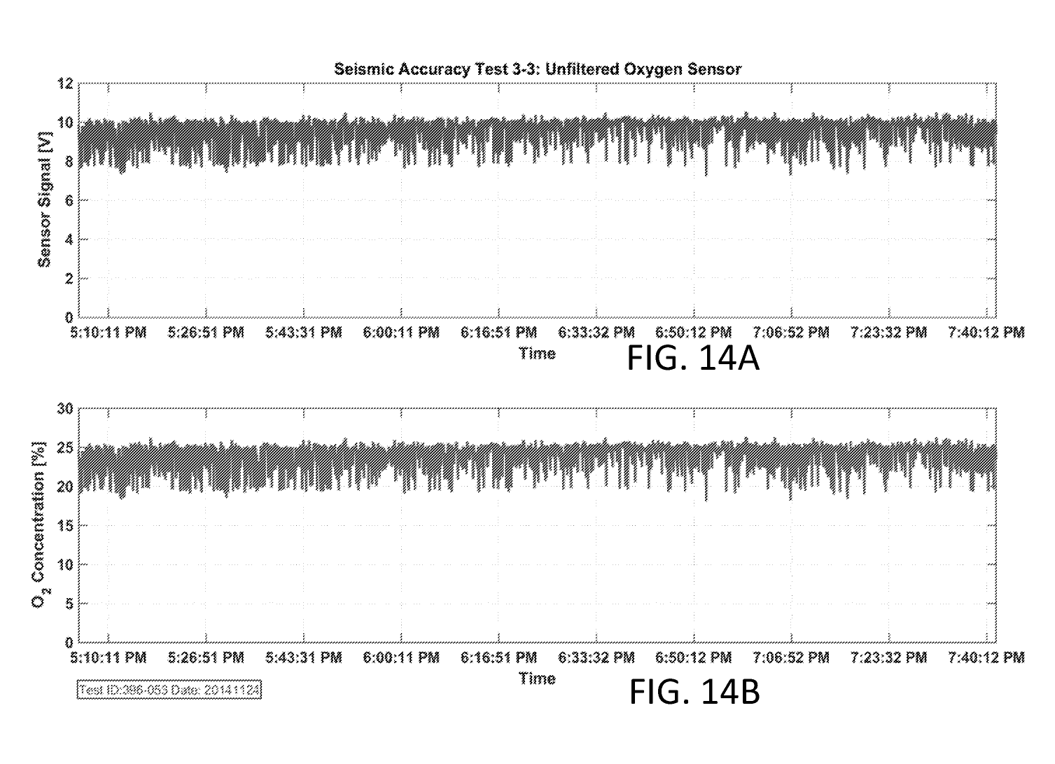

Referring to FIGS. 12A-14B, example sensor results are illustrated. FIGS. 12A-14B illustrate different sensor outputs after seismic exposure. All sensors remained stable through all testing with no loss of signal or damage. For each sensor, performance results are shown in terms of raw output (i.e. sensor resistance output), and reported concentration of hydrogen or oxygen. While FIGS. 12A-14B illustrate some noise in the data, seismic exposure had no impact on test results. FIGS. 12A and 12B illustrate hydrogen concentration (12B) from high temperature hydrogen sensor 205 and corresponding sensor resistance (12A). FIGS. 13A and 13B illustrate hydrogen concentration (13B) from low temperature hydrogen sensor 206 and corresponding sensor resistance (13A). FIGS. 14A and 14B illustrate oxygen concentration (14B) from oxygen sensor 209 and corresponding sensor signal (14A).

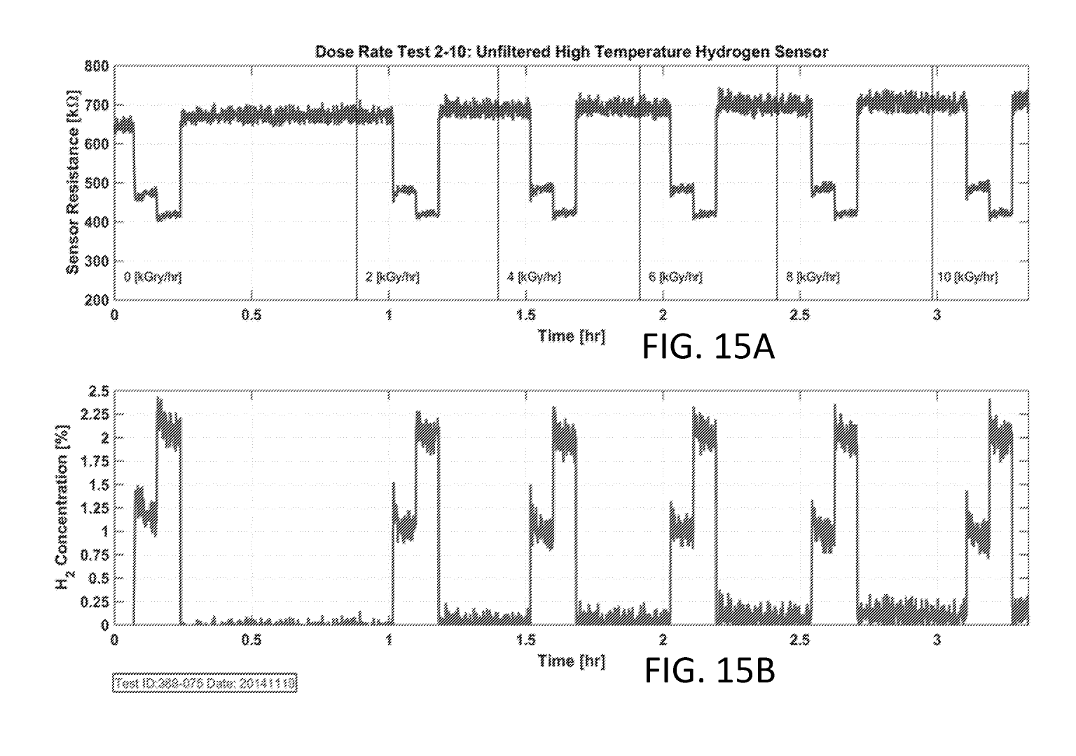

With reference to FIGS. 15A and 15B, example sensor results are illustrated. In one embodiment, sensors 205, 206, 208, 209, 210, and 211 are exposed to high levels of radiation to confirm robustness of gas monitoring system 100. Dose rate test results for high temperature hydrogen sensor 205 show stable sensor performance over stepwise radiation exposures of 0 kGy/hr to 10 kGy/hr.

In addition to development of algorithm 402, sensor tests under radiation, seismic, and poisoning test conditions generated new concepts that may be incorporated into gas monitoring system 100. Carbon monoxide may be emitted within nuclear containment under accident conditions when fuels leaks from a reactor and contacts concrete floors and walls of the containment structure. Hydrogen sensors 205, 206, adapted for use as carbon monoxide sensors, as described above, may exhibit strong sensitivity to carbon monoxide, showing a large drop in electric resistance, similar in response to detecting hydrogen. While separation of H₂ and CO response may not be possible within a single GMU, strategic placement of multiple GMUs within containment could be used to distinguish H₂ and CO. Alternatively, a GMU may also be used as a total gas sensor, indicating total combustible gas concentration (i.e. concentrations of H₂ and CO), since both are flammable and may indicate accident conditions. Such a GMU may be used for accident mitigation.

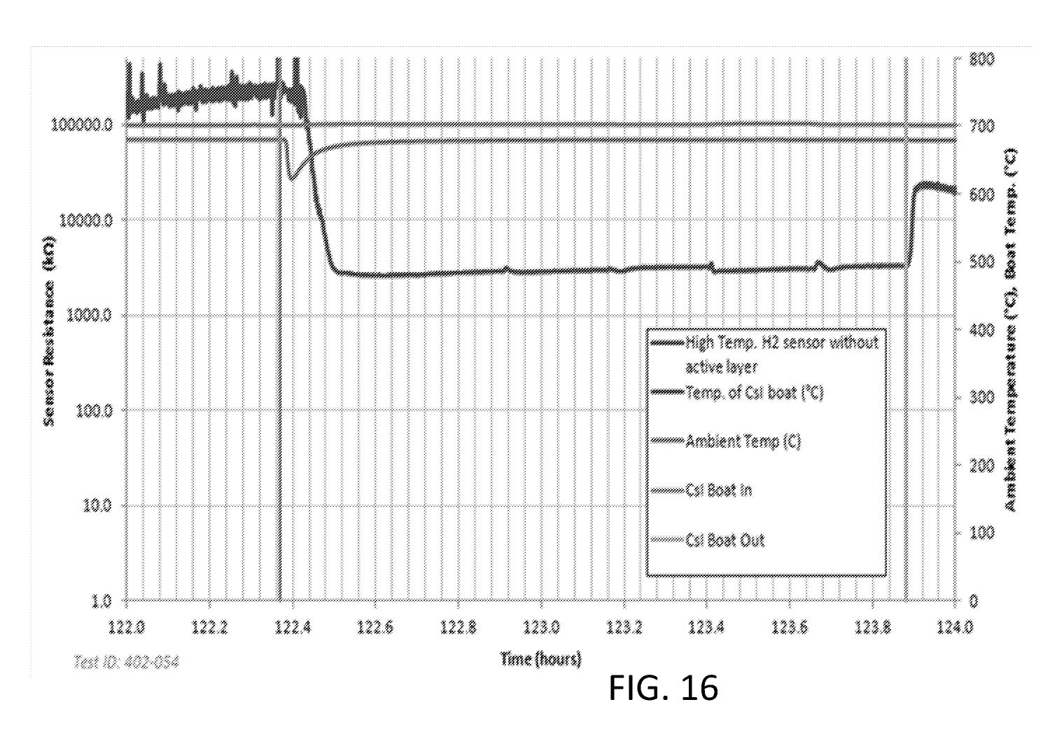

With reference to FIG. 16, example sensor sensitivity is illustrated. FIG. 16 illustrates sensor 205 sensitivity to cesium iodide. Sensor 205 response indicates that cesium iodide may be electrically conductive, and that a response, as illustrated, may have been caused by CsI depositing onto a sensor surface and creating a conductive path across an inter-digital electrode (IDE). A blank IDE (no hydrogen sensitive coating) was tested and provided a similar response. Accordingly, sensor 205 may be employed as a CsI sensor.

Unless specifically stated to the contrary, the numerical parameters set forth in the specification, including the attached claims, are approximations that may vary depending on the desired properties sought to be obtained according to the exemplary embodiments. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the systems, methods, and apparatuses have been illustrated by describing example embodiments, and while the example embodiments have been described and illustrated in considerable detail, it is not the intention of the applicants to restrict, or in any way limit, the scope of the appended claims to such detail. It is, of course, not possible to describe every conceivable combination of components or methodologies for purposes of describing the systems, methods, and apparatuses. With the benefit of this application, additional advantages and modifications will readily appear to those skilled in the art. Therefore, the invention, in its broader aspects, is not limited to the specific details and illustrative example and exemplary embodiments shown and described. Accordingly, departures may be made from such details without departing from the spirit or scope of the general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

As used in the specification and the claims, the singular forms “a,” “an,” and “the” include the plural. To the extent that the term “includes” or “including” is employed in the detailed description or the claims, it is intended to be inclusive in a manner co-extensive with the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. Finally, where the term “about” is used in conjunction with a number, it is intended to include ±10% of the number. In other words, “about 10” may mean from 9 to 11.

What is claimed:

1. A gas monitoring system for nuclear reactors comprising:
a gas monitoring unit within a reactor containment;
a gas monitoring unit controller outside of the reactor containment; and
a cable connecting the gas monitoring unit to the gas monitoring unit controller.

2. The gas monitoring system of claim 1, wherein the gas monitoring unit further comprises:
a stainless steel enclosure;
at least one hydrogen sensor;
a pressure sensor;
an oxygen sensor;
a temperature sensor;
at least one of a relative humidity sensor and a steam sensor;
a circuit board;
high temperature wires;
terminal blocks; and
a flame arrestor,
wherein the gas monitoring unit is of a material robust to at least one of: nuclear radiation, pressure, temperature, steam, and low oxygen concentrations.

3. The gas monitoring system of claim 2, wherein the at least one hydrogen sensor is a high temperature hydrogen sensor comprising a hydrogen-selective porous composite, the hydrogen-selective porous composite further comprising a cerium oxide, wherein a hydrogen-comprising gas contacting the hydrogen-selective porous composite causes at least one of: a decrease in electrical resistance, a change in sensitivity, and a deviation from a baseline operation of a hydrogen-selective porous composite.

4. The gas monitoring system of claim 2, wherein the at least one hydrogen sensor is operable at an ambient temperature up to 700° C. and an ambient pressure up to 1.3 MPa, and wherein the at least one hydrogen sensor comprises at least one of: an electrochemical hydrogen sensor, a chemi-resistive hydrogen sensor, a catalytic hydrogen sensor, and a metal oxide semi-conductive hydrogen sensor.

5. The gas monitoring system of claim 2, wherein the at least one hydrogen sensor comprises a porous hydrogen-selective composite material comprising a dope cerium oxide selected from the group chosen from: zirconium-doped ceria, gadolinium-doped ceria, samarium-doped ceria, lanthanum-doped ceria, yttrium-doped ceria, calcium-doped ceria, strontium-doped ceria, and a mixture thereof; a modifier comprising at least one of: tin oxide, indium oxide, titanium oxide, copper oxide, tungsten oxide, molybdenum oxide, nickel oxide, niobium oxide, or vanadium oxide; and a noble metal promoter comprising one or more of: palladium, ruthenium, platinum, gold, rhodium, and iridium.

6. The gas monitoring system of claim 2, wherein the at least one hydrogen sensor is operable at an ambient temperature in a range of 25° C. to 150° C., and wherein the lower temperature hydrogen sensor comprises at least one of: an electrochemical hydrogen sensor, a chemi-resistive hydrogen sensor, a catalytic hydrogen sensor, and a metal oxide semi-conductive hydrogen sensor.

7. The gas monitoring system of claim 2, wherein the oxygen sensor is operable at an ambient temperature in a range from 25° C. to 700° C. and a pressure ranging from a vacuum to 1.3 MPa, and wherein the oxygen sensor is operable to detect oxygen in concentrations in a range from 0% to 25%, and wherein the oxygen sensor comprises at least one of: an yttrium stabilized zirconium oxide oxygen sensor, a gadolinium or samarium doped cerium oxide oxygen sensor, and a titanium oxide based oxygen sensor.

8. The gas monitoring system of claim 2, wherein the pressure sensor is operable at an ambient temperature in a range from 25° C. to 700° C., and wherein the pressure sensor is operable to detect pressure from 0 MPa to at least 1.3 MPa.

9. The gas monitoring system of claim 2, wherein the humidity sensor is operable to measure a relative humidity in a nuclear containment environment from 0% to 100% relative humidity.

10. The gas monitoring system of claim 2, wherein at least one of the humidity sensor and the steam sensor is operable to measure a steam content in a nuclear containment environment in a temperature range from 25° C. to 700° C. and a pressure ranging from a vacuum to 1.3 MPa.

11. The gas monitoring system of claim 2, wherein the temperature sensor is operable to measure a temperature in a range from 25° C. to 700° C., and wherein the temperature sensor is at least one of: a resistance temperature device, a thermistor, and a thermocouple.

12. The gas monitoring system of claim 2, wherein the gas monitoring unit comprises only one hydrogen sensor, and wherein the gas monitoring system is operable to operate continuously at a temperature of 700° C. and a pressure of 1.3 MPa.

13. The gas monitoring system of claim 2, wherein an operating temperature or power control loop and corresponding calibration are adjusted in the gas monitoring unit controller depending on an ambient temperature measured by the temperature sensor or a sensor embedded temperature sensor.

14. The gas monitoring system of claim 2, wherein the gas monitoring unit controller further comprises: an electronic control circuit, at least one hardware, and a software.

15. The gas monitoring system of claim 2, wherein the at least one hydrogen sensor is operable to measure carbon monoxide.

16. The gas monitoring system of claim 2, wherein the at least one hydrogen sensor is operable to measure at least one of: cesium iodide, methyl iodide, iodine, and other nuclear fuel contaminants.

17. The gas monitoring system of claim 1, wherein the gas monitoring unit is oriented outside of the reactor containment.

18. A method for monitoring gases in a nuclear reactor, the method comprising the acts of:
reading an input signal from at least one of: the at least one hydrogen sensor, the pressure sensor, the oxygen sensor, the temperature sensor, and the relative humidity sensor;
processing the input signal through a calibration and sensor deconvolution algorithm in a software to obtain information about a reactor containment environment; and
communicating the information of the reactor containment environment as at least one of:
feedback to another instrumentation for the nuclear reactor;
display information output on a display panel or electronic display; and
data to be recorded to a data acquisition system.

19. A method for detecting hydrogen gas, the method comprising the acts of:
providing a hydrogen sensor comprising a hydrogen-selective porous composite comprising a cerium oxide;
providing a hydrogen-comprising gas;
contacting the hydrogen-comprising gas with the hydrogen-selective porous composite; and
detecting hydrogen in the hydrogen-comprising gas according to at least one of: a decrease in electrical resistance, a change in sensitivity, or a deviation from baseline operation of a hydrogen-selective porous composite.

20. The method of claim 19, wherein the hydrogen-selective porous composite comprising a doped cerium oxide selected from the group chosen from: zirconium-doped ceria, gadolinium-doped ceria, samarium-doped ceria, lanthanum-doped ceria, yttrium-doped ceria, calcium-doped ceria, strontium-doped ceria, and a mixture thereof; a modifier comprising at least one of: tin oxide, indium oxide, titanium oxide, copper oxide, tungsten oxide, molybdenum oxide, nickel oxide, niobium oxide, or vanadium oxide; and a noble metal promoter comprising one or more of: palladium, ruthenium, platinum, gold, rhodium, and iridium.
